(19) United States
(12) Patent Application Publication
(10) Pub. No.: US 2025/0262726 A1
(43) Pub. Date: Aug. 21, 2025

(54) Tool with Pivoting Head

(71) Applicant: Milwaukee Electric Tool Corporation, Brookfield, WI (US)

(72) Inventors: Matthew A. Wills, Shorewood, WI (US); Parker E. Tibbs, Milwaukee, WI (US)

(21) Appl. No.: 19/022,239

(22) Filed: Jan. 15, 2025

Related U.S. Application Data
(60) Provisional application No. 63/568,810, filed on Mar. 22, 2024.
(60) Provisional application No. 63/555,239, filed on Feb. 19, 2024.

(51) Int. Cl. B25B 23/00; B25B 13/46

(52) U.S. Cl. CPC B25B 23/0028; B25B 13/46

(57) ABSTRACT

Various embodiments of a tool with a pivoting head and locking mechanism are provided. The tool includes a handle and a head that is pivotable relative to the handle. The tool includes a locking mechanism adjustable between a locked position and an unlocked position. In one embodiment, the locking mechanism is biased toward remaining in the locked position when in the locked position and biased toward remaining in the unlocked position when in the unlocked position. In another embodiment, the locking mechanism includes a rotating switch coupled to a lock shuttle that is offset from a central axis of the handle. In another embodiment, the locking mechanism includes a rotating switch coupled to the lock shuttle, the rotating switch includes a projection configured to engage a retention step of the shuttle.

### CROSS REFERENCE TO RELATED PATENT APPLICATIONS

The present application claims the benefit of and priority to U.S. Provisional Application No. 63/568,810, filed Mar. 22, 2024, and to U.S. Provisional Application No. 63/555,239 filed Feb. 19, 2024, and which are incorporated herein by reference in their entireties.

### BACKGROUND OF THE INVENTION

The present disclosure is directed generally to a tool, such as a ratchet wrench, with a pivoting head. The present disclosure relates specifically to a ratchet wrench with a pivoting head and a locking mechanism that locks the head at the desired pivoted position.

### SUMMARY OF THE INVENTION

An embodiment of the invention relates to a driving tool. The driving tool includes a handle extending along a longitudinal axis and a head coupled to the handle such that the head is pivotable about a pivot joint to a plurality of angular positions relative to the handle. The head includes a toothed projection extending toward the handle. The driving tool further includes a workpiece engagement structure coupled to the head and a locking mechanism. The locking mechanism includes an engagement member. The engagement member includes a locking end, a bore, and a ledge. The locking end is configured to engage the head. The bore extends though the engagement member and the ledge is positioned within the bore. The locking mechanism further includes a control mechanism coupled to the engagement member. The control mechanism includes an actuator, a shaft extending from the actuator where the shaft extends into the bore, and a projection extending radially outward from the shaft.

Another embodiment of the invention relates to a driving tool. The driving tool includes a handle extending along a longitudinal axis and a head coupled to the handle. The driving tool further includes a workpiece engagement structure coupled to the head and a pivot joint positioned between the handle and the head. The pivot joint couples the handle to the head such that the head is pivotable about the pivot joint to a plurality of angular positions relative to the handle. The driving tool includes a slot defined in the handle and a locking mechanism. The locking mechanism includes a sliding switch positioned in the slot, the switch is moveable along the longitudinal axis. The switch includes a locking end that is configured to engage the head. The locking mechanism further includes a retaining member extending through the sliding switch, a first recess, and a second recess spaced from the first recess along the longitudinal axis. The locking mechanism is moveable between a locking position in which the angular position of the head relative to the handle is fixed and an unlocked position in which the head is pivotable about the pivot joint.

Another embodiment of the invention relates to a driving tool. The driving tool includes a handle extending along a central, longitudinal axis and a head coupled to the handle such that the head is pivotable about a pivot joint to a plurality of angular positions relative to the handle. The driving tool further includes a workpiece engagement structure coupled to the head and a locking mechanism. The locking mechanism includes an engagement member with a locking end configured to engage the head and a protrusion. The locking mechanism further includes a control mechanism that includes an actuator, a shaft extending from the actuator into the handle and an open section defined in the shaft. The open section is configured to receive the protrusion of the engagement member to couple the engagement member to the control mechanism. The locking mechanism is moveable between a locked position in which the angular position of the head relative to the handle is fixed and an unlocked position in which the head is pivotable about the pivot joint.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a ratchet wrench with a pivoting head and slide lock, according to an exemplary embodiment.

FIG. 2 is a cross-sectional view of the ratchet wrench with the pivoting head of FIG. 1, according to an exemplary embodiment.

FIG. 3 is an isolated view of the head of the ratchet wrench of FIG. 1, according to an exemplary embodiment.

FIG. 4 is a top view of the ratchet wrench with the pivoting head of FIG. 1 in a locked state, according to an exemplary embodiment.

FIG. 5 is a top view of the ratchet wrench with the pivoting head of FIG. 1 in an unlocked state, according to an exemplary embodiment.

FIG. 6 is a perspective view of a ratchet wrench with a pivoting head and rotating lock, according to an exemplary embodiment.

FIG. 7 is a top view of the ratchet wrench with the pivoting head of FIG. 6, according to an exemplary embodiment.

FIG. 8 is an isolated perspective view of the rotating lock of the ratchet wrench with the pivoting head of FIG. 6, according to an exemplary embodiment.

FIG. 9 is an isolated perspective view of the rotating lock of the ratchet wrench with the pivoting head of FIG. 6, according to an exemplary embodiment.

FIG. 10 is a perspective view of a ratchet wrench with a pivoting head, according to another exemplary embodiment.

FIG. 11 is a top view of the ratchet wrench with the pivoting head of FIG. 10, according to an exemplary embodiment.

FIG. 12 is a bottom view of the ratchet wrench with the pivoting head of FIG. 10, according to an exemplary embodiment.

FIG. 13 is a perspective view of the ratchet wrench with the pivoting head of FIG. 10 with the handle removed.

FIG. 14 is an exploded view of a locking mechanism of the ratchet wrench of FIG. 10, according to an exemplary embodiment.

FIG. 15 is a cross-sectional view of the locking mechanism of the ratchet wrench with the handle removed, according to an exemplary embodiment.

FIG. 16 is a top view of the ratchet wrench of FIG. 10 in a locked position, according to an exemplary embodiment.

FIG. 17 is detailed view from below of the locking mechanism in the locked position, according to an exemplary embodiment.

FIG. 18 is a top view of the ratchet wrench of FIG. 10 in an unlocked position, according to an exemplary embodiment.

FIG. 19 is detailed view from below of the locking mechanism in the unlocked position, according to an exemplary embodiment.

### DETAILED DESCRIPTION

Referring generally to the figures, various embodiments of a tool, such as a ratcheting wrench with a pivoting head and locking mechanism, are provided. In various embodiments, the tool includes a locking mechanism that engages the pivoting head to hold or lock the pivoting head at a desired angular position relative to the head. Some conventional ratchet wrenches include locking mechanisms that are always biased toward the locked position, which can cause unintended locking when adjusting the angular position of the pivoting head. In certain embodiments discussed herein, the locking mechanism is designed to be held or maintained in either the locked or the unlocked state as selected by the user.

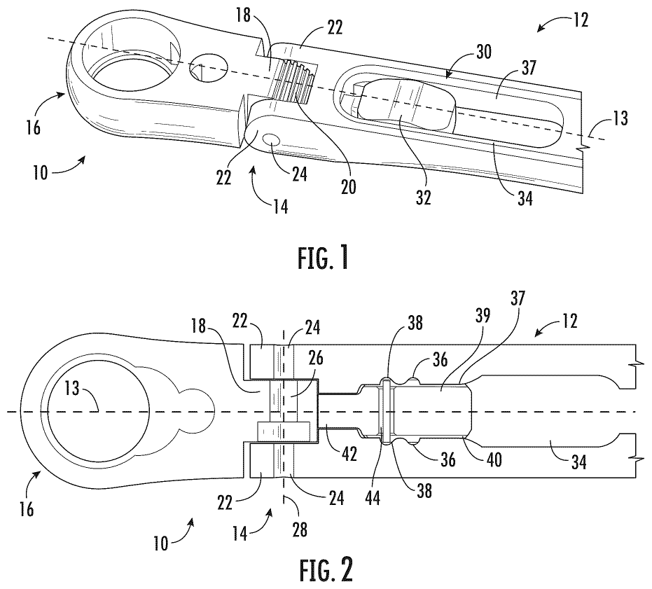

Referring to FIG. 1, a driving tool, such as wrench 10, is shown according to an exemplary embodiment. In the embodiment shown, wrench 10 is a ratchet wrench including a tool body or handle 12 extending along a longitudinal axis 13, a pivot joint 14 and a pivoting portion, shown as head 16. In general, pivot joint 14 is located between handle 12 and head 16 and allows the user to change the angular position of head 16 relative to handle 12.

In some embodiments, head 16 includes a workpiece engagement structure with a ratchet mechanism. The workpiece engagement structure can be any structure that allows for engagement of a workpiece (e.g., a fastener, a bolt, a nut, etc.). Handle 12 acts as a handle and lever to apply torque to the workpiece. In specific embodiments, the workpiece engagement structure is an open wrench head, a closed wrench head, a screwdriver head, a post configured to releasably engage a socket, etc. In some embodiments, head 16 is configured to support a ratchet mechanism coupled to the workpiece engagement structure such that the ratchet mechanism provides ratcheting action to the workpiece engagement structure. The ratchet mechanism is a mechanical structure that allows for free or unrestricted rotation of handle 12 around the workpiece engagement structure in a first direction and allows for restricted or driving rotation of handle 12 around the workpiece engagement structure in a second direction opposite of the first direction. Wrench 10 may include a selection mechanism that allows the user to select which rotational direction provides driving rotation and which provides free rotation. In a specific embodiment, the ratchet mechanism includes a gear structure, one or more pawls and a biasing component.

Referring to FIGS. 1 and 2, a driving tool, shown as a wrench 10 includes a pivot joint 14 that allows the user to adjust the angular position of head 16 relative to handle 12. Head 16 includes a projection 18 extending toward handle 12 along longitudinal axis 13. Projection 18 includes a plurality of toothed projections or splines 20. Handle 12 includes a pair of arms or flanges 22 that extend toward head 16 in a direction parallel to longitudinal axis 13 from an engagement end of handle 12. Arms 22 each include openings 24 that are oriented perpendicularly to longitudinal axis 13 and align with each other. As shown in FIG. 2, projection 18 includes a channel 26 and is positioned between arms 22 such that channel 26 and openings 24 are aligned along a rotational axis 28. In some embodiments, head 16 is rotatably coupled to handle 12, such as by a pin or axel that extends along rotational axis 28 and passes through openings 24 and channel 26.

Wrench 10 includes a locking mechanism 30 that allows the user to selectably and reversibly lock head 16 in a desired angular position relative to the handle 12. Locking mechanism 30 includes a switch 32 located within a slot 34 of handle 12. In various embodiments, slot 34 is an elongate slot. In various specific embodiments, slot 34 is defined in an outward, longitudinal surface of handle 12. In such embodiments, slot 34 extends through only a portion of handle 12. In other words, in such embodiment, slot 34 does not extend through handle 12 and switch 32 can only be actuated from a single side of wrench 10.

As shown in FIG. 2, slot 34 includes a first recess or detent 36 and a second recess or detent 38 spaced from the first detent 36 along longitudinal axis 13. In various embodiments, slot 34 includes a third recess or detent 36 that opposes or faces the first detent 36 and a fourth recess or detent 38 that opposes or faces the second detent 38. In various specific embodiments, handle 12 and specifically slot 34 includes a first set or pair of recesses or detents 36 and a second set of recesses or detents 38. First set of detents 36 is spaced apart from second set of detents 38 along longitudinal axis 13 such that first set of detents 36 is located between second set of detents 38 and a distal end of handle 12. Second set of detents 38 is located between first set of detents 36 and rotational axis 28 with respect to longitudinal axis 13. In a specific embodiment, first set of detents 36 and/or second set of detents 38 include two detents located on opposing sides of handle 12 with respect to longitudinal axis 13. In other words, first set of detents 36 and second set of detents 38 are defined on laterally inward facing surfaces 37 of handle 12 and more specifically slot 34. In other words, inward facings surfaces 37 each face toward longitudinal axis 13.

Locking mechanism 30 includes a shuttle 40 rigidly coupled to switch 32. In a specific embodiment, switch 32 and shuttle 40 are integrally formed as a single, continuous, contiguous component. Shuttle 40 has a locking or engagement end 42 that is configured to engage splines 20 of head 16 to lock head 16 at an angular position with respect to handle 12. Shuttle 40 also includes a retaining member 44 configured to be releasably retained within either first set of detents 36 or second set of detents 38. In some embodiments, retaining member 44 includes one or more retractable ball-nose ends configured to fit within either first set of detents 36 or second set of detents 38. In various specific embodiments, retaining member 44 extends in a generally perpendicular (e.g., 90 degrees plus or minus 10 degrees) orientation to longitudinal axis 13. In various embodiments, retaining member 44 extends through switch 32 and between lateral facing surfaces 39 of switch 32. When switch 32 is positioned within slot 34, lateral facing surfaces 39 face inward facing surfaces 37 of handle 12.

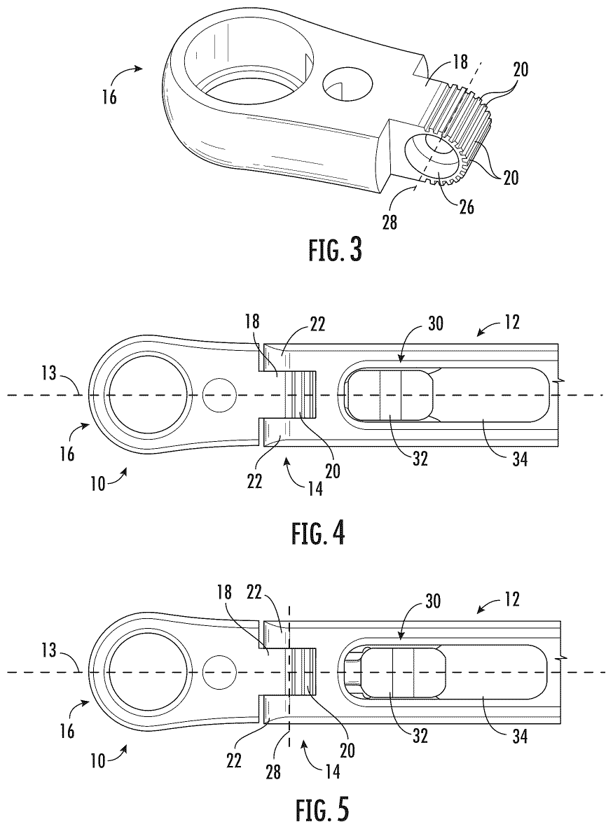

Referring to FIG. 3, an isolated view of head 16 is shown, according to an exemplary embodiment. In a specific embodiment, the plurality of splines 20 are spaced circumferentially about a portion of projection 18 with respect to rotational axis 28. Splines 20 are place along an arcuate surface of projection 18 that extends through an arc angle of between 210 and 135 degrees with respect to rotational axis 28, and specifically, through an angle of about 180 degrees. The configuration of splines 20 around projection 18 allows users to lock head 16 into a plurality of angular positions with respect to handle 12.

Referring to FIGS. 4 and 5, locking mechanism 30 is moveable between a locked position, shown in FIG. 4, in which the angular position of head 16 relative to handle 12 is fixed and an unlocked position, shown in FIG. 5, in which head 16 is pivotable about rotational axis 28. To adjust the locking mechanism 30 into the locked position, the user moves switch 32 parallel to longitudinal axis 13 toward head 16 such that locking end 42 of shuttle 40 is engaged and in contact with splines 20 of head 16. To adjust locking mechanism 30 into the unlocked position, the user moves switch 32 parallel to longitudinal axis 13 away from head 16 such that locking end 42 of shuttle 40 is not in contact with splines 20 of head 16.

Referring back to FIG. 2, when locking mechanism 30 is in the locked position, retaining member 44 is releasably retained within second set of detents 38 such that locking end 42 of shuttle 40 engages splines 20 of head 16 until sufficient force is applied to switch 32 to remove retaining member 44 from second set of detents 38. Similarly, when locking mechanism 30 is in the unlocked position, retaining member 44 is releasably retained within first set of detents 36 such that locking end 42 does not engage splines 20 of head 16 until sufficient force is applied to switch 32 to remove retaining member 44 from second set of detents 38. Unlike some conventional rotatable wrench head locking mechanisms that are always biased toward a locked position, the configuration of retaining member 44, first set of detents 36 and second set of detents 38 provides a locking mechanism that is stably held or maintained in both a locked position and an unlocked position.

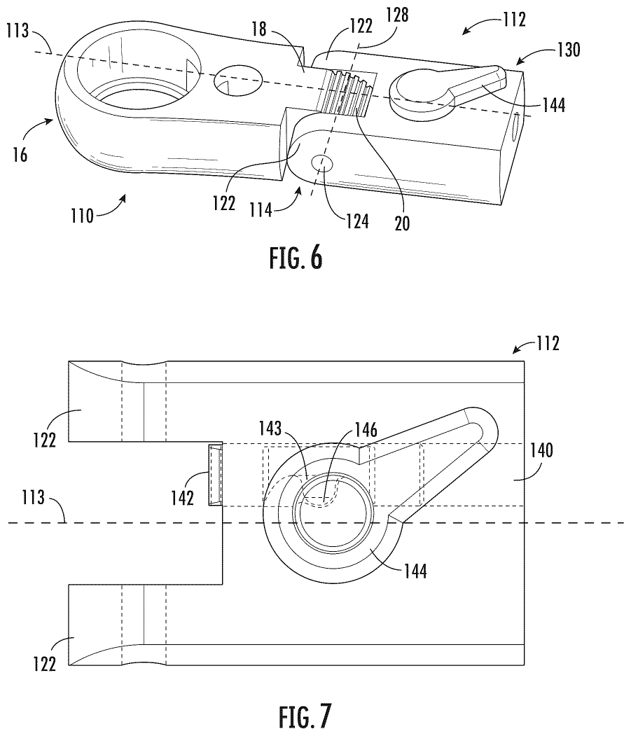

Referring to FIGS. 6-9, wrench 110 is shown, according to an exemplary embodiment. Wrench 110 is substantially similar to wrench 10 except for the differences discussed herein. As discussed in greater detail below, Applicant has designed additional embodiments of a locking mechanism for a tool with a pivoting head and locking mechanism. Some conventional ratchet wrenches with locking mechanisms that include a rotational switch have a lock shuttle for engaging the wrench head that is centered within the handle portion of the wrench. In certain embodiments discussed herein, the locking mechanism includes a rotational switch and a lock shuttle that is offset from the central axis of the wrench handle. Applicant believes this configuration results in a secure locking mechanism that requires fewer and simpler components than some conventional designs which may provide for a smaller sized locking mechanism suitable for a smaller sized tool.

As shown in FIG. 6, wrench 110 includes a handle 112 extending along a longitudinal axis 113 that forms a pivot joint 114 with head 16. Handle 112 includes arms 122 having openings 124, and a locking mechanism 130 having a control mechanism shown as a rotating lever 144. Similar to wrench 10, openings 124 align with channel 26 of head 16, shown in FIG. 3, along a rotational axis 128.

Referring to FIG. 7, locking mechanism 130 further includes an engagement member, shown as shuttle 140 having a locking end 142 and a shuttle protrusion 143. Shuttle protrusion 143 extends from a shaft of shuttle 140. In specific embodiments, protrusion 143 is positioned between locking end 142 and an opposing end of shuttle 140. Locking end 142 is configured to engage toothed projections or splines 20 of head 16 to fix the angular position of head 16 with respect to handle 112. Rotating lever 144 includes an open section or recessed section 146 located on a portion of rotating lever 144 within handle 112 and configured to receive shuttle protrusion 143 to couple shuttle 140 to rotating lever 144.

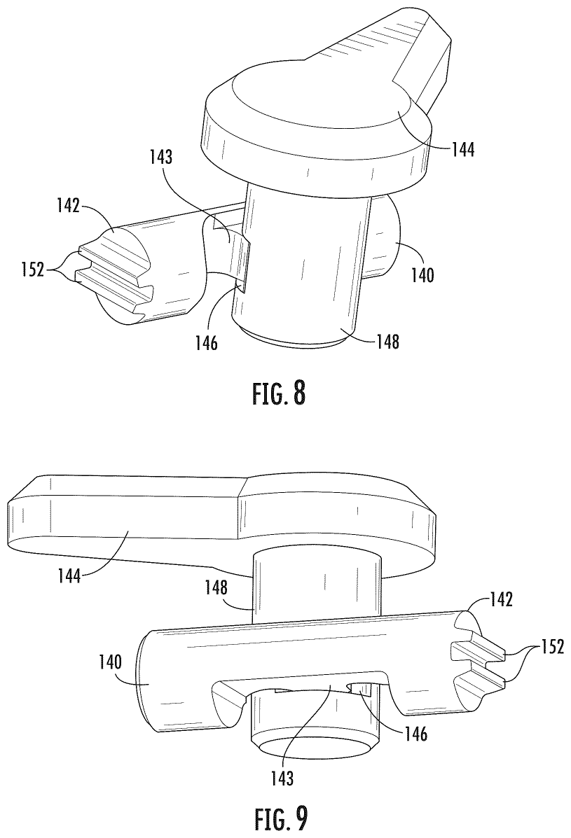

As shown in FIG. 8, rotating lever 144 also includes a lever shaft 148 that extends the actuating portion of lever 144 downward along an axis of rotation of rotating lever 144. Open section 146 is located on lever shaft 148. When wrench 110 is assembled, lever shaft 148 is located within the body of handle 112. Referring to FIGS. 8 and 9, shuttle 140 includes a plurality of teeth 152. Teeth 152 extend from locking end 142 and are configured to cooperate with and engage splines 20 of head 16.

Rotating lever 144 allows users to actuate locking mechanism 130 between a locked position and an unlocked position. When rotating lever 144 is set in the locked position, as shown in FIGS. 6 and 7, teeth 152 on locking end 142 of shuttle 140 are in contact with and engage splines 20 of head 16, fixing the angular position of head 16 with respect to handle 112. Locking mechanism 130 can be actuated from the locked position to an unlocked position by rotating lever 144 clockwise. Referring back to FIG. 7, shuttle 140 is offset with respect to longitudinal axis 113 of handle 112. By offsetting shuttle 140 from a centerline of handle 112 (i.e. longitudinal axis 113), the rotational motion of rotating lever 144 is transferred to translational motion of shuttle 140. In other words, shuttle 140 is positioned on one side of the central longitudinal axis 113. In specific embodiments, shuttle 140 is positioned entirely on one side of the central, longitudinal axis or centerline.

As rotating lever 144 rotates, the surfaces forming the sides of open section 146 push shuttle protrusion 143 such that shuttle 140 slides translationally in a direction parallel to longitudinal axis 113. When rotating lever 144 is set in the unlocked position, locking end 142 of shuttle 140 is spaced apart from splines 20 of head 16 such that head 16 can pivot about rotational axis 128 with respect to handle 112. The configuration of open section 146, shuttle protrusion 143, and shuttle 140 being offset from longitudinal axis 113 provides for a rotating locking mechanism that is easily actuated between a locked and unlocked position while only requiring two components.

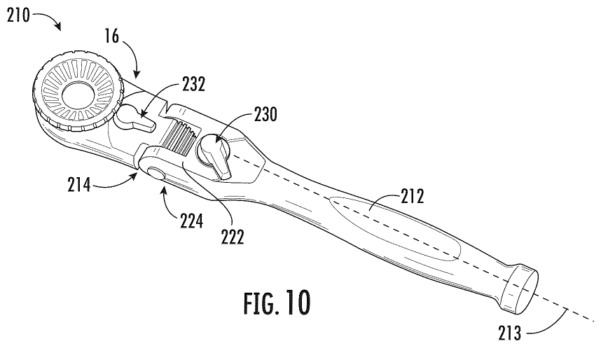

Referring to FIGS. 10-19, wrench 210 is shown, according to an exemplary embodiment. Wrench 210 is substantially similar to wrench 10, 110 except for the differences discussed herein. As discussed in greater detail below, Applicant has designed additional embodiments of a locking mechanism for a tool with a pivoting head and locking mechanism. Some conventional ratchet wrenches with locking mechanisms that include a rotational switch have a lock shuttle for engaging the wrench head that may have unwanted shuttle movement (such as when wrench is dropped) that causes the switch to disengage. In certain embodiments discussed herein, the locking mechanism includes a rotational switch and a lock shuttle that includes a retention step or ledge configured to engage with a projection on the switch. Applicant believes this configuration results in a secure locking mechanism that requires fewer and simpler components than some conventional designs which may provide for a more secure engagement between the shuttle and switch.

Referring to FIGS. 10-12, driving tool, shown as a wrench 210 includes a pivot joint 214 that allows the user to adjust the angular position of head 16 relative to handle 212. Head 16 includes a projection 18 extending toward handle 212 along longitudinal axis 213. Projection 18 includes a plurality of toothed projections or splines 20. Handle 212 includes a pair of arms or flanges 222 that extend toward head 16 in a direction parallel to longitudinal axis 213 from an engagement end of handle 212. Arms 222 each include openings 224 that are oriented perpendicularly to longitudinal axis 213 and align with each other. Projection 18 includes a channel (see e.g., 26 in FIG. 3) and is positioned between arms 222 such that channel and openings 224 are aligned along a rotational axis 228.

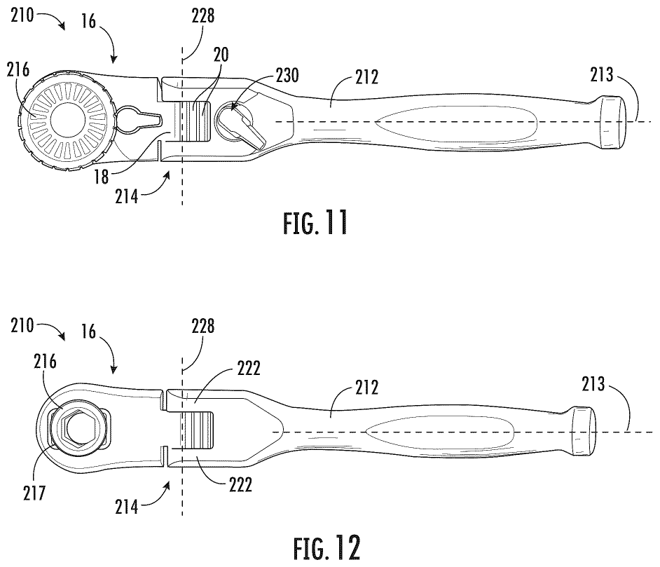

In various specific embodiments, wrench 210 and specifically head 16 supports a thumbwheel 216. As can be seen in FIG. 12, a retention clip 217 is positioned along a rear surface of head 16 to secure thumbwheel 216 to wrench 216. Wrench 210 includes a reverse switch 232 configured to change the driving direction of wrench 210. Wrench includes a control mechanism shown as locking mechanism 239 which includes an engagement member shown as shuttle 234 engaged or coupled to switch an actuator shown as locking switch 230. In a specific embodiment, switch 230 and shuttle 234 are each integrally formed as a single, continuous, contiguous components.

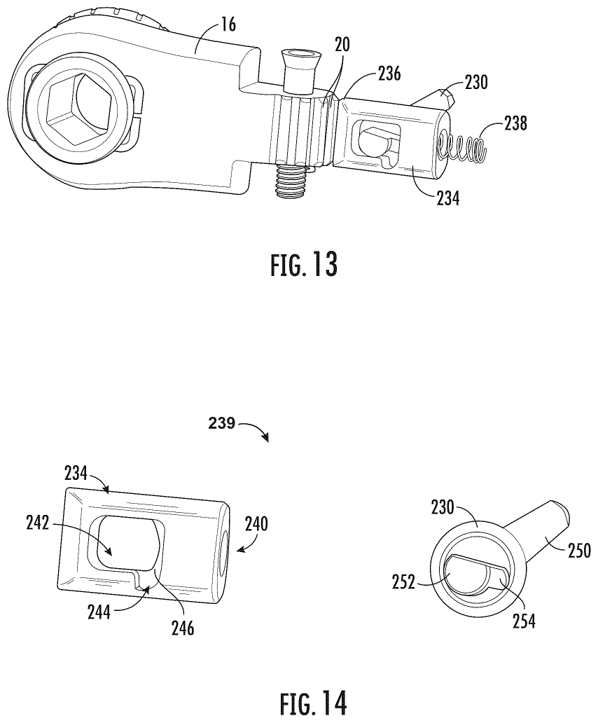

Referring to FIGS. 13-15, details of locking mechanism 239 are shown according to an exemplary embodiment. Shuttle 234 has a locking or engagement end that is configured to engage splines 20 of head 16 to lock head 16 at an angular position with respect to handle 212. In various embodiments, shuttle 234 includes one or more teeth or splines 236 configured to engage with splines 20. Shuttle 234 further includes a channel 240 defined in a surface that opposes splines 236 (e.g., faces away from head 16). A biasing component, shown as spring 238 is positioned within channel 240 of shuttle 234. In various specific embodiments, channel 240 and/or spring 238 are aligned along longitudinal axis 213.

Shuttle 234 further includes a switch bore 242 configured to receive locking switch 230. As previously discussed, Applicant believes the engagement between shuttle 234 and switch 230 provides more secure engagement and reduces the likelihood of disengagement between components if wrench 210 is dropped. Switch bore 242 includes a recessed portion 244 with a ledge or retention step 246. In other words, the ledge 246 is connected to or positioned within the bore 242. In specific embodiments, switch bore 242 extends through shuttle 234 in a generally perpendicular orientation (e.g., 90 plus or minus 10 degrees) to longitudinal axis 213 and pivot axis 228. In specific embodiments, switch bore 242 extends through the entire shuttle 234 (e.g., from top surface to bottom surface).

As shown in FIG. 14, locking switch 230 includes an actuator or lever 250 connected to a shaft 252. Locking switch 230 further includes a projection 254 extending radially outward from a portion of shaft 252. In various specific embodiments, projection 254 is a single projection extending from shaft 252. In other words, shaft 252 includes only one projection 254. In various embodiments, lever 250 extends radially in a first direction and projection 254 extends radially in a second direction. In specific embodiments, the first direction and the second direction are different. In other words, the radial extension of projection 254 is not aligned with lever 250.

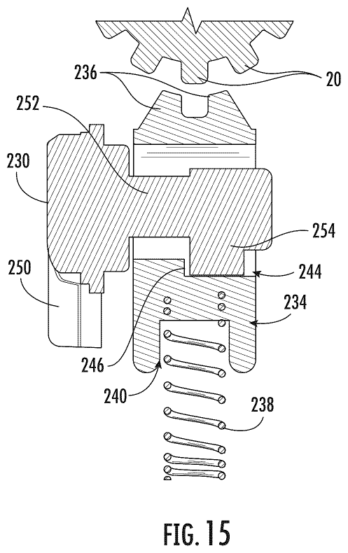

When locking mechanism 239 is assembled, projection 254 of locking switch 230 is positioned within recessed portion 244 while shaft 252 is positioned within a main portion of the switch bore 242. Further, when locking switch 230 is positioned within bore 242, an end of locking switch 230 and more specifically shaft 252 extends beyond or past an end of switch bore 242. In other words, the end of shaft 252 is not flush with the end of switch bore 242 (see e.g., FIG. 15).

In various embodiments, projection 254 is an asymmetrical projection. In specific embodiments, projection 254 is a singular asymmetrical projection. In specific embodiments, an outermost radial surface of projection 254 is curved. In various embodiments, locking switch 230 and more specifically shaft 252 includes a planar portion extending along a longitudinal axis of the shaft 252. In specific embodiments, shaft 252 has a non-circular cross-sectional shape. In other words, in specific embodiments, shaft 252 is not symmetrical.

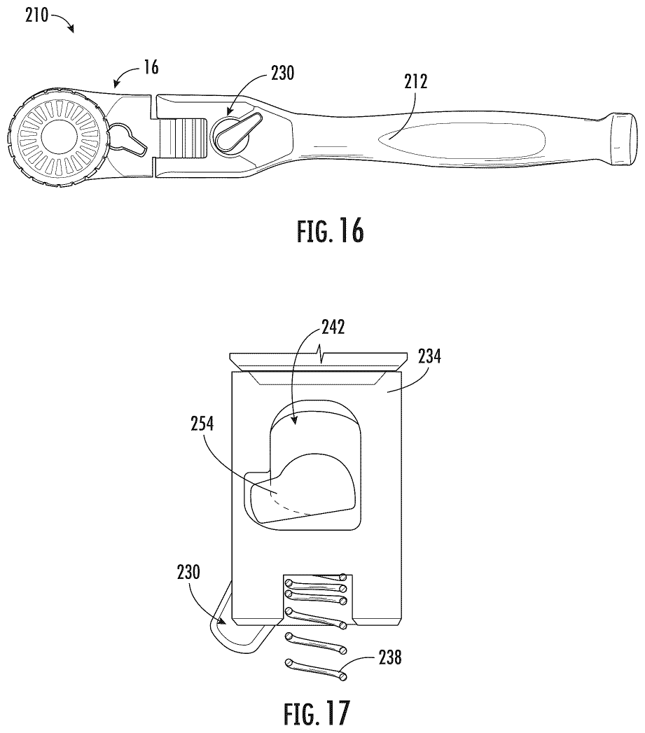

Referring to FIGS. 16-19, details of locking mechanism 239 moving between a locked and unlocked position are shown according to an exemplary embodiment. As shown in FIGS. 16-17, when locking switch 230 is rotated in a first direction (e.g., counterclockwise direction), projection 254 is moved into recessed portion 244 of shuttle 234 to provide secure engagement between shuttle 234 and locking switch 230. More specifically, projection 254 is positioned above retention step 246 (in the orientation shown in FIG. 17) and therefore resists movement of locking switch 230 relative to shuttle 234. As previously discussed, Applicant believes the reduced space of recessed portion 244 reduces the likelihood of locking switch 230 falling out of or disengaging from shuttle 235 during a forceful event like dropping of wrench 210.

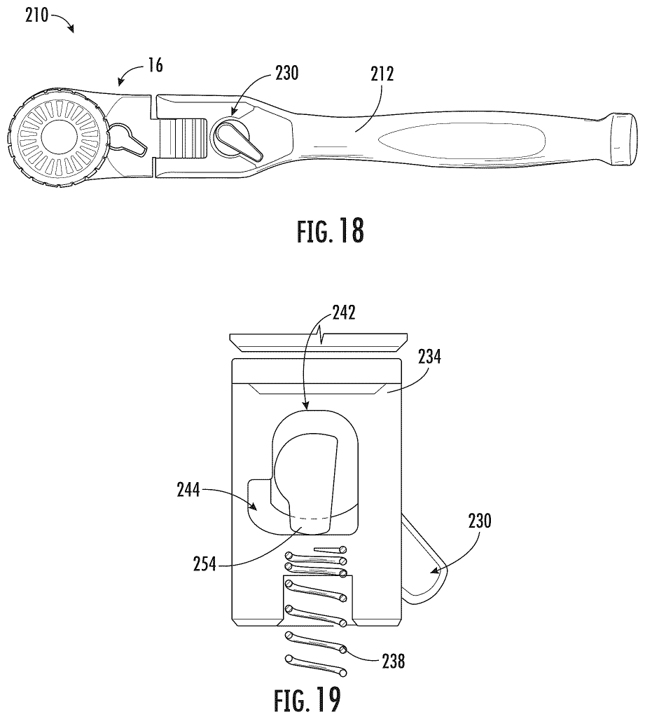

As shown in FIGS. 18-19, when locking switch 230 is rotated in a second direction that opposes the first direction (e.g., clockwise direction), projection 254 is moved out of recessed portion 244 of shuttle 234. More specifically, projection 254 of locking switch 230 is moved away from recessed portion 244 and toward the longitudinal axis 213 and/or biasing component 238.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A driving tool, comprising:
a handle extending along a longitudinal axis;
a head coupled to the handle such that the head is pivotable about a pivot joint to a plurality of angular positions relative to the handle, the head including a toothed projection extending toward the handle;
a workpiece engagement structure coupled to the head;
a locking mechanism, the locking mechanism comprising:
an engagement member, the engagement member comprising:
a locking end, the locking end configured to engage the head;
a bore extending through the engagement member; and
a ledge positioned within the bore; and
a control mechanism coupled to the engagement member, the control mechanism comprising:
an actuator;
a shaft extending from the actuator, wherein the shaft extends into the bore; and
a projection extending radially outward from the shaft.

2. The driving tool of claim 1, wherein the locking mechanism is moveable between a locked position in which the angular position of the head relative to the handle is fixed and an unlocked position in which the head is pivotable about the pivot joint.

3. The driving tool of claim 2, wherein, when the locking mechanism is in the locked position, the ledge resists movement of the projection of the control mechanism within the bore.

4. The driving tool of claim 2, wherein, when the locking mechanism is in the unlocked position, the projection is spaced from the ledge.

5. The driving tool of claim 1, wherein the bore of the engagement member includes a recessed portion that is at least partially defined by the ledge.

6. The driving tool of claim 5, wherein the recessed portion extends along the longitudinal axis and away from the head.

7. A driving tool, comprising:
a handle extending along a longitudinal axis;
a head;
a workpiece engagement structure coupled to the head;
a pivot joint positioned between the handle and the head, the pivot joint coupling the handle to the head such that the head is pivotable about the pivot joint to a plurality of angular positions relative to the handle;
a slot defined in the handle; and
a locking mechanism comprising:
a sliding switch positioned in the slot, the switch moveable along the longitudinal axis, the switch comprising:
a locking end, the locking end configured to engage the head;
a retaining member extending through the sliding switch;
a first recess; and
a second recess spaced from the first recess along the longitudinal axis;
wherein the locking mechanism is moveable between a locked position in which the angular position of the head relative to the handle is fixed and an unlocked position in which the head is pivotable about the pivot joint.

8. The driving tool of claim 7, further comprising a first inward facing surface of the handle positioned in the slot, wherein the first recess and second recess are positioned on the first inward facing surface.

9. The driving tool of claim 8, further comprising:
a second inward facing surface of the handle positioned in the slot, the second inward facing surface opposing the first inward facing surface;
a third recess positioned on the second inward facing surface; and
a fourth recess positioned on the second inward facing surface and spaced from the third recess along the longitudinal axis.

10. The driving tool of claim 9, wherein the third recess faces the first recess and wherein the fourth recess faces the second recess.

11. The driving tool of claim 9, wherein, when the retaining member is engaged with the first recess the retaining member is engaged with the third recess.

12. The driving tool of claim 7, wherein, when the retaining member is engaged with the first recess, the sliding switch is spaced from the head and secured in the unlocked position.

13. The driving tool of claim 12, wherein, when the retaining member is engaged with the second recess, the sliding switch is engaged with head and secured in the locked position.

14. The driving tool of claim 7, wherein the retaining member extends in a generally perpendicular orientation to the longitudinal axis between opposing inward facing surfaces of the slot.

15. A driving tool, comprising:
a handle extending along a central, longitudinal axis;
a head coupled to the handle such that the head is pivotable about a pivot joint to a plurality of angular positions relative to the handle;
a workpiece engagement structure coupled to the head;
a locking mechanism, the locking mechanism comprising:
an engagement member, the engagement member comprising:
a locking end, the locking end configured to engage the head; and
a protrusion; and
a control mechanism comprising:
an actuator;
a shaft extending from the actuator, wherein the shaft extends into the handle; and
an open section defined on the shaft and configured to receive the protrusion of the engagement member to couple the engagement member to the control mechanism;
wherein the locking mechanism is moveable between a locked position in which the angular position of the head relative to the handle is fixed and an unlocked position in which the head is pivotable about the pivot joint.

16. The driving tool of claim 15, wherein the engagement member is positioned on a side of the central, longitudinal axis of the handle.

17. The driving tool of claim 15, wherein the engagement member is offset from the central, longitudinal axis of the handle.

18. The driving tool of claim 15, wherein, when the actuator is moved in a first direction to the locked position, the shaft is rotated such that the locking end of the engagement member is engaged with the head.

19. The driving tool of claim 18, wherein, when the actuator is move in a second direction to the unlocked position, the shaft is rotated such that the locking end of the engagement member is spaced from the head.

20. The driving tool of claim 15, wherein the protrusion of the engagement member extends from a shaft of the engagement member and is positioned between the locking end and a distal end that opposes the locking end.
